(19) United States
(12) Patent Application Publication
(10) Pub. No.: US 2008/0189334 A1
(43) Pub. Date: Aug. 7, 2008

(54) Method of Global Popularity based Prioritization in Information Engine with Consumer ==Author and Dynamic Web models for global, multimedia, and mobile Internet

(76) Inventor: Anup Kumar Mathur, Sunnyvale, CA (US)

Correspondence Address: Anup Mathur, 1731 Chitamook Ct., Sunnyvale, CA, 94087, US

(21) Appl. No.: 12/013,414

(22) Filed: Jan. 11, 2008

Related U.S. Application Data
(60) Provisional application No. 60/884,607, filed on Jan. 11, 2007.

(51) Int. Cl. G06F 17/30

(52) U.S. Cl. 707/104.1; 707/E17.001

(57) ABSTRACT

With consumers becoming authors, i.e. “consumers==authors” model, the new web is growing at an ever faster pace, making the job of a search engine more complex than most present day search engines were designed for. In this new generation of web, information and content is “Multi-media” and/or “Mobile” friendly, and created by either “Professional authors, or Consumers or Applications” and is available as “Traditional web” or “Dynamic web” or on demand “Web service”. The new method introduces a paradigm shift from present day search engines to the new “Information Engine” that models this author and consumer set of actions to create, acquire, communicate and consume information across various sources, with information prioritization, computed as “Global Popularity Index”, and presentation for global, multimedia, and mobile Internet.

### PRIORITY CLAIM

This application is related to and claims priority under 35 U.S.C. §119(e) to a commonly assigned provisional patent application entitled “Method of Information Engine with Make-Share-Search for Multi-media and Mobile Global Internet” by Anup Kumar Mathur, Application Ser. No. 60/884,607 filed on Jan. 11, 2007, including but not limited to specification numbers 1, 19, 20, 21, 23 and 27.

### KEYWORDS

Web Page Relevance, Search, Search Engine, Popularity, Context Search, Context Similarity, Web Page Ranking, Search Session, Probabilistic distribution for search results, Context based relevance, Time based relevance, Location based relevance, Age Appropriateness based relevance, Language Based Relevance, Media based relevance.

### REFERENCES

USPTO reference patents snapshot: See Appendix 1
Wikipedia reference snapshot: See Appendix 2

### REVISIONS

First Created Nov. 17, 2006 Anup Mathur
Provisional Filing Update Jan. 3, 2007 Anup Mathur
Utility Filing Update Jan. 11, 2008 Anup Mathur
Utility Filing Revision Apr. 2, 2008 Anup Mathur

### BACKGROUND OF INVENTION

Current state of art for search results ranking is the based on ranking web pages that rate highest by number of links that point to a web page, and importance of such linking web pages which increases such ranking, and which is achieved by distributing probability of user clicking on a link to this web page, in either uniform or non-uniform manner across all links; iteratively developing a rank for all web pages across global Internet.

This current method is fine for most searches, and has gained significant success, but it fails for simple cases, such as where new information of interest to intended consumer is produced by an author or another consumer, and being new very few or no other pages link to it, and thus resulting in lower relevance in present day models. Hence only those pages show high in relevance which are “authored and linked to” by major web directories or news media sites as being “important” and that contain the keywords, irrespective of whether such web pages are the most relevant, or most recent or most interesting for what the user is really looking for in the present context. As older information gathers more such links pointing to it, this method is unfairly biased against newly created yet more relevant information; which then requires time oriented decay policies to enforce newness. While this method of ranking web pages is superior to what ever existed before this, simple failures with respect to new information demonstrate that this method may not be a fair and equitable basis to going forward. Hence, any further improvements on this model may lead to further degeneration of model from what the consumer is really interested in.

Further, even as present search engine model is designed and may be considered well suited for the Web 1.0 environment, as the Internet transitions to the new Web 2.0 and beyond, with Consumers created content expects to outpace professional content, and with more web pages becoming dynamic, and more applications opening up to service information on demand to consumers, the search ranking method for primarily designed for traditional web pages or Web 1.0 is no longer sufficient.

### BRIEF SUMMARY OF INVENTION

With consumers becoming authors, the new web is growing at an ever faster pace, making the job of a search engine more complex than most present day search engines were designed for. In this new generation web, information and content is “Multi-media” and/or “Mobile” friendly, and created by either “Professional authors, Consumers or Applications” and is available as “Traditional web” or “Dynamic web” or on demand “Web service” or variants thereof. This new method introduces a paradigm shift from present day “Search Engines” to the new “Information Engine” that brings together “creation, origination, prioritization, search, availability and utilization” of information from each and every source of information.

In particular, the prioritization of information is computed as “Global Popularity Index” to form the basis for servicing relevant information to web and mobile users worldwide on demand. The method takes advantage of following characteristics of modern Internet:
Consumer and Author interest in creating, communicating and consuming information of interest as clearly and quickly as possible.
Each person can be an author as well as consumer, in the new “Consumer==Author” model, breaking away from the traditional web of professionally authored web pages and directory or aggregator services.
This model requires a new method of search for information, as often such consumer generated pages may contain more relevant and early information but may not be pointed to by so called important web pages.
The rate at which such consumer created content is modified or newly created is significantly faster than traditional or professional web pages; and over time it can be expected that consumer generated content will far exceed professional content.
The new global web not only consist of professional text oriented web pages but goes beyond to have miscellaneous “Multi-media” content including consumer and professional videos, music, photos, documents and like, as well as “Mobile” camera phone generated text messages, photos and videos, streaming news, consumer created web pages, blogs and Wikis', and other emerging forms.
The new global web also increasingly consists of “Dynamic web” pages where data is computed against a query, and web page so created is presented to the user.
This is further complicated by increasing trend towards HTTP/XML, RSS feeds, SOAP/WSDL/REST based Web Services, etc. where these services provide information through application interfaces over the Internet or Mobile networks, and not through traditional web page model.
Consumers desire to search for new information of interest with specific context across all these various sources but with limited patience and time.
Consumers and authors have means including and beyond traditional PCs to create and consume information such as mobile PCs, mobile phones, media center PCs, and even game consoles and personal media devices, which they are expecting to increasingly use for information creation and access.
Hence a new system called “Information Engine” provides comprehensive information creation, search, access and utilization across all these various static or dynamic sources, media, services and access methods, with information prioritization and presentation in response to query from user, or automated user agents, end user applications and business applications.
A new method of “information prioritization” called method of “Global Popularity Index” is presented in view of the complexity of the new “Information Engine”, which allows prioritization across all of these various information sources and to meet rich consumer requirements and usefulness.

### DESCRIPTION OF INVENTION AND EMBODIMENTS

Introducing the “Consumer==Author” Model in which every consumer is also an author or creator, and vice versa, Number of new web pages or content items or information elements created and/or modified every second is significant, and may far exceed or may have already exceeded number of professional web pages. Naturally such a consumer author also expects that the newly created or modified web page, content or information is immediately made available to other interested consumers.

While such content has newness in its favor, the number of other important web pages that link to it are few or none, yet such new content may in some cases have higher degree of contextual relevance to what the consumer is looking for.

Further, both consumers and professionals are creating or publishing a variety of “multi-media” content moving beyond simple html text pages to news, photos, videos, music, podcasts, e-books, e-bids and like. From a business perspective, presentations, documents, workshop proceedings and like are increasingly being published over the web, and hence are forming a completely different aspect of multi-media content.

Gaming and related areas are yet another set of content which has its own set of authors and consumers, and in some cases, these games take on embodiments which are similar to real life, and thus, users of such games are interested therefore in searching for within such environment, with a possible draw of parallel search in the real world. On the other hand, e-books and e-shows are expected to become more popular, as hardware enables such e-books or e-shows to be viewed at a low cost handheld devices, and hence e-books, e-shows and like form yet another type of multi-media content. These new trends in the web require new methods of searching for information, and traditional html web page oriented search and relevance model of web do not represent these new complexities adequately.

Moving forward, as applications become more web ready and systems can create web pages with dynamic data, a new notion of invisibility in web is emerging, which has the right information but is not searchable by traditional search engines. This trend is likely to increase as more businesses attempt to make their web pages dynamic i.e. change as the business situation changes; yet would like their potential consumers or customers to be able to find such web pages.

Finally, there are many web pages which are created by consumers but not linked to by any other web page or professional web page. This can create notion of darkness in the web where web pages exist, but will not appear in search results or will appear too low in search engine prioritization, given no links point to these, and even as it is possible that such web pages may contain information that user is looking for. The only method today is to know the web page or web site address and directly use browser to bring it up; which leads to many such pages which users will not be able to find.

Modeling this author and consumer set of actions to create, communicate and consume information requires this new method with Information acquisition across various information sources, information results prioritization, computed as Global Popularity Index, and presentation in the Information Engine environment with Consumer==Author and Dynamic Web models for global, multimedia, and mobile Internet.

The new method identifies each of the information sources from these various models of creation and communication, uniquely, and computes a “Global Popularity Index” for each of such uniquely identifiable sources, universally. Against an information query or request by end users, automated user agents or client applications, via web or mobile access methods, Information Engine uses this global popularity index to identify best sources of information, finds the information, and presents the information directly to the user in a user agent such as web browser, mobile browser or a client application. The user agent can then format the information in user desirable manner to present to user as per user preference or per selected standardized format or make use of information in a “consumer process” or “business process”.

In a basic model, “Global Popularity Index” (or GPI) is computed for traditional web page of web 1.0 environment, that is uniquely addressable through a uniform resource locator (or URL); the GPI is computed using a “Information access probability” along potential click-through “URL paths” leading to and originating from such a web page, and distributes probabilities across and deep along all such paths. This distribution is successively done along the path nodes, and is automatically cutoff using a “Threshold probability value” effectively limiting number of maximum nodes along any path traversal in a dynamic manner, using law of diminishing returns along each path traversal. It may be noted that method enables access to nodes that may have only one terminating link to them, yet may have several paths that may lead to them, which may originate several nodes away and traverse through the single incoming link. Further, the larger the number of paths passing through a node, the method yields higher priority to them. Further, the importance of a web page is determined by number and quality of paths passing through it.

A key aspect of Global Popularity Index method is to take advantage of “Contextual Similarity” along the path traversal, given that users are more likely to follow paths that have contextual similarity, and yet for each information query, user may have a different and new context in mind. User traversal probabilities along any path may be uniformly distributed or be weighted based on some criterion, such as paths that lead to similar context web pages as being more likely to be of interest to user, by determining Context Similarity, where context similarity criterion can be defined in one or more ways, and based on what defines context. In one embodiment, this could be simply a comparison of the high frequency non-trivial words between two successive nodes along a path, where in the high frequency non-trivial words present the notion of context of a web page. In another embodiment, authors may be asked to explicitly indicate context by way of entering contextual information at the time of creation, and hence such explicitly stated context could also be used as one of the parameters to compute contextual similarity.

The “context Similarity” so determined is combined with “Threshold probability level” to create a solution which leads to “higher probability distribution along paths that are contextually similar”, while “limiting or reducing the distribution along paths that are less contextually similar”. This creates a unique model which favors deeper travel along paths which are more relevant, as would be the case for a real user, while quickly snapping back for cases where little or no contextual similarity exists. This model also improves convergence of the algorithm during computation, as many paths are likely to have low contextual similarity and hence lower probability will be allocated, and hence computation will stop sooner due to cut off level being reached. For the case, where these is truly higher contextual similarity, algorithm will pursue that further by allocating higher probability, which will eventually drop below threshold level; but in the process uncover more relevant material than otherwise.

An observation here is that more the “number of paths that pass through a node”, more the probability that this node will gather; even though the number of incoming links to this node may not be high. For example, a node may have only one incoming and one outgoing link, yet it may have several URL paths with high “Context Similarity” flowing through it. This would be the case for user created new material, which will usually not attract high number of links, yet may be reachable from an important page through a contextually relevant path. This shifts the balance to a more neutral level, between professional web pages and consumer web pages, in favor of more contextual relevance.

Further, creating the concept of “User Model of Searching for Information” in which user starts at a node on the web (such as a web page or search result) and traverses along a path, and may retrace back to session start node, to start along another path (such as another link on the start web page or another search result). This model leads to distribution of probability not only to forward nodes along path but also sideways along other paths, which accounts for typical user behavior of clicking through several levels deep before retracing to start again along another path. This is accomplished in a simple manner when probability is distributed back along each path in addition to forward, or equivalent.

Click-through probabilities may also be distributed to account for start with a completely different node in the global web, but within the same “effective search session” i.e. with “contextual similarity” and while maintaining the option to back track to original node. This would be the case, for example, if the user performs another slightly modified search while still looking for the same information and hence comes up with a different set of results, which he or she then pursues further; and yet, may find that the earlier results were more relevant and hence jumps back to earlier results. Further, the method introduces the notion of the new “ability to back track entire results” and not just “back web pages” as is available in present day browsers.

For the basic model, the above set of methods is carried out in an iterative manner for all nodes of the global web, where a node is a web page or content item based on universal resource locator (URL) or similar global addressing scheme, until a convergence criterion is met such as cut off probability variation level being reached, resulting in a “global popularity index” of a web page, information, or content item.

For meeting the enhanced requirements of new Information Engine, a new multi-media model of information and content is created. This new Multi-media model provides three levels, which are “element, Page and Document”. Here an element may be a photo or video clip or podcast, or a single information interface of a web service or a single dynamic web element of a dynamic web page etc., Whereas a page is a collection of one or more elements with some support structure and text describing to create an equivalent yet new generation web page, And a document is a collection of several pages, with a sense of continuation of context or story. This model allows creation of a presentation in web environment, which typically consists of many slides, and each slide consists of text and pictures or graphics; and thus each of its slides now maps to what used to be web pages, while each slide may consist of one or more elements with multimedia nature; and yet the entire presentation is addressable as a document. Each element is considered uniquely addressable, and so are pages and documents. Further each element may be linked to by one or more pages, and each page may be linked to by one or more documents, thus creating a flexible yet more accurate representation of the new web.

The Global popularity Index is now computed for each of the three levels. Further, since each level of element can influence its lower and higher levels, the method further allows for increase or reduction of GPI, based on GPI of its container and contained items.

From an end user view point, this method translates to improving relevance of a web page if the underlying photo turns out to be relevant and popular. In generalizing this method, GPI can be computed for every photo, every video clip, as well as for every show or program that contain such photos and video clips. The method allows for contextual similarity computations based on anchor or caption words that describe such an element, or page or document, or can use full text based similarity model of a web page described earlier, in text based situations. Further, if a multi-media annotation layer is present, and defined by the author or authors or automatically captured by device or application, information on such a layer is used for contextual similarity computation, as well as for basic identification i.e. against keywords and topics etc.

The three level method of Multi-media gets simplified to two level, i.e. element and page, where no contextual similarity can be identified between pages and thus no document element is identified to hold several pages together. For most of present day web, this simplified solution of two levels applies; however, as more complex models of e-books and e-shows gain popularity, three level model will be more useful. Either-way, method applies to two level and three level multi-media contents, as well as is extensible to n-level multi-media content, and hence is flexible enough to represent current and future professional or consumer created content and services in the Information Engine model.

Enhancing the basic “Global Popularity Index” method, provides search across multiple information sources, or different information views on the global Internet, and ability of user to search across all of these various information sources in a single information search or “effective search session” i.e. maintaining contextual similarity. Such repositories may range from live news feeds, less frequently modified yet important web pages created by professionals, more frequently modified web pages and content created by consumers, mobile web pages and mobile content, dynamic web pages that determine data on run time from live applications and databases, software services that present information through software application interfaces, and/or web services on the global Internet.

The method identifies each such information source uniquely. Once identified, the method identifies all the paths that lead to each such information source, be it a web page, a web service or dynamic web page or like. Context of each source is identified through its descriptors, which in case of a web service are provided through models such as WSDL. Contextually similar static and dynamic web sources are therefore identified along each path, thus creating means to allocate probabilities along paths not just to static or traditional web pages, but also to dynamic web pages, web services and other non-traditional and new information sources. A Global Popularity Index is computed for each of the nodes i.e. information source of Information Engine, which is then used at the time of user query to prioritize the information source. If the information source is static such as traditional web page, the method trivializes to GPI calculation as already described. Where-as if the information source is dynamic, then also GPI calculation brings forward all the relevant services or dynamic web content, allowing the information to be computed on demand for the highest priority information source across static and dynamic sources in a single solution. The results from static and dynamic sources are computed and presented to users through a user agent, or mobile user agent, or utilized by application for business or consumer use.

This method of bringing together all the information sources in a single solution is defined as the new “Information Engine” that gets created and hence users can query for new information across all the various sources, and thus creating novel and useful functionality for consumers and businesses worldwide.

Through the above description, a new method and system of Information Engine is defined which models the new generation of web and mobile environment, including multimedia, mobile, and consumer==author models, as well as provides for web services and dynamic web models of the global Internet.

Information Engine results prioritization or information relevance method is defined by computing Global Popularity Index. Global Popularity Index is computed based on various paths that pass through Information Nodes, and computing information access probability in static web and dynamic web environment.

The combined method improves on the current state of technology in web search for the global consumer audience of the Internet and presents alternate variants which can enhance the method for specific context, including but not limited to, time, location, age appropriateness, media type, language type and similar considerations to create search results more suited for users or special purpose needs, or present multiple result segments based on different considerations, giving end users more complete view of information.

See Appendix 1 and Appendix 2 for capture of current state of art as per current state of patents/applications as provided by USPTO and current state of industry as per Wikipedia snapshot.

### BRIEF DESCRIPTION OF THE SEVERAL VIEWS OF THE DRAWINGS

Referring to the enclosed drawings:

FIG. 1, in one embodiment of the invention, Access Probability Distribution along URL Path is shown where probabilities are multiplied in successive Information Nodes, to dramatically reduce the effect as one goes from second node (i.e. p*p) to third node (i.e. p*p*p). Such Access Probability Distribution is computed for each Information Node of the Information Engine, where such Information Node may be static or dynamic element, page, document or service.

FIG. 2, in one embodiment of the invention, Context Similarity is utilized to compute probability for each Information Node, with forward, backward and residual probability model. Such Contextual Similarity based probability distribution is computed for each Information Node of the Information Engine, where such Information Node may be static or dynamic element, page, document or service.

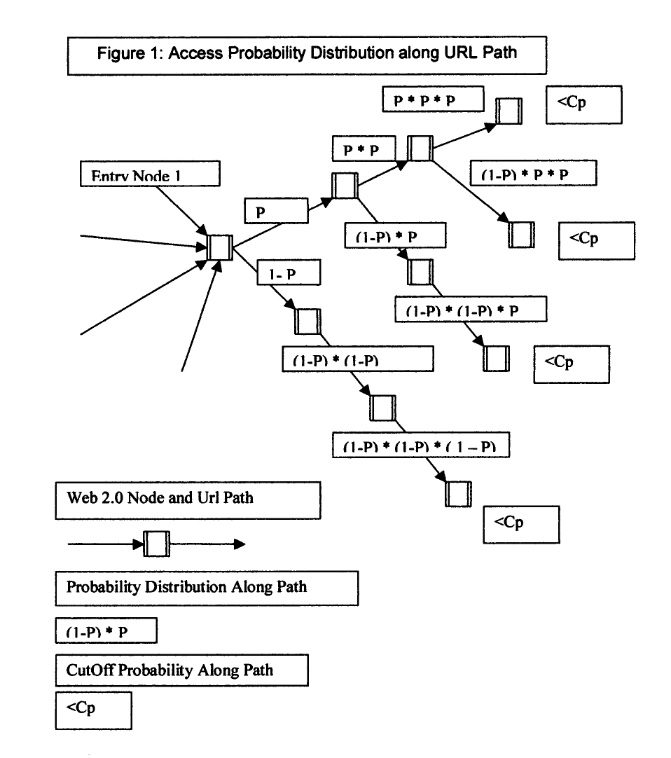

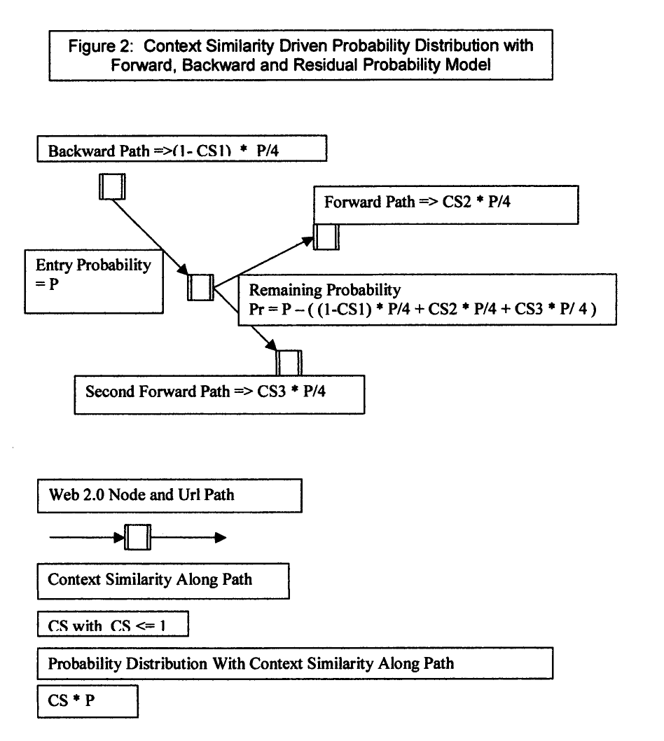

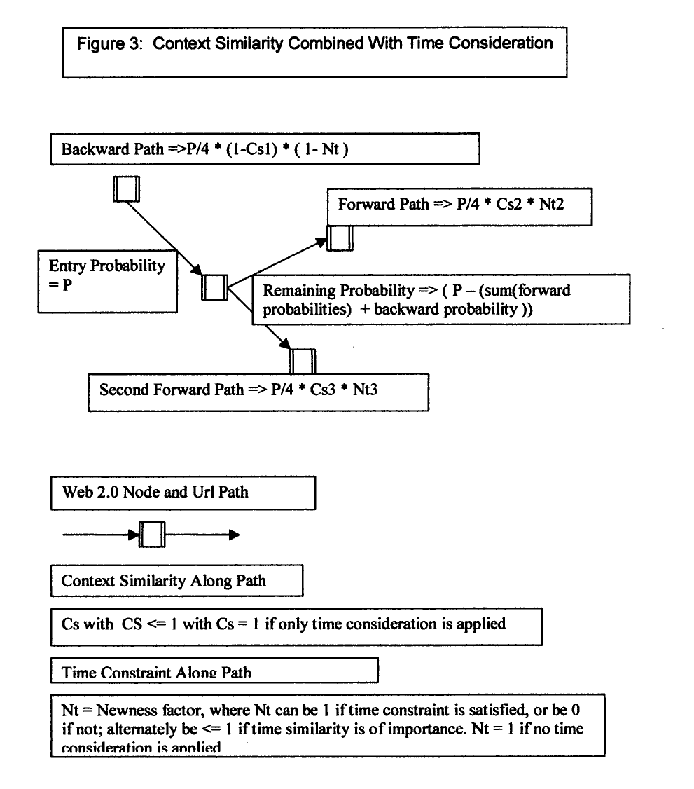

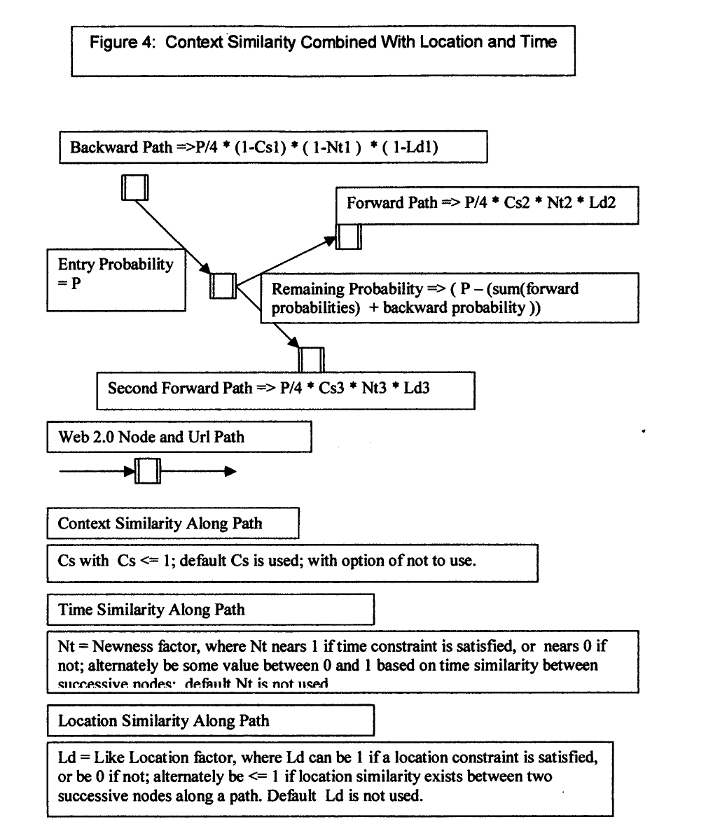

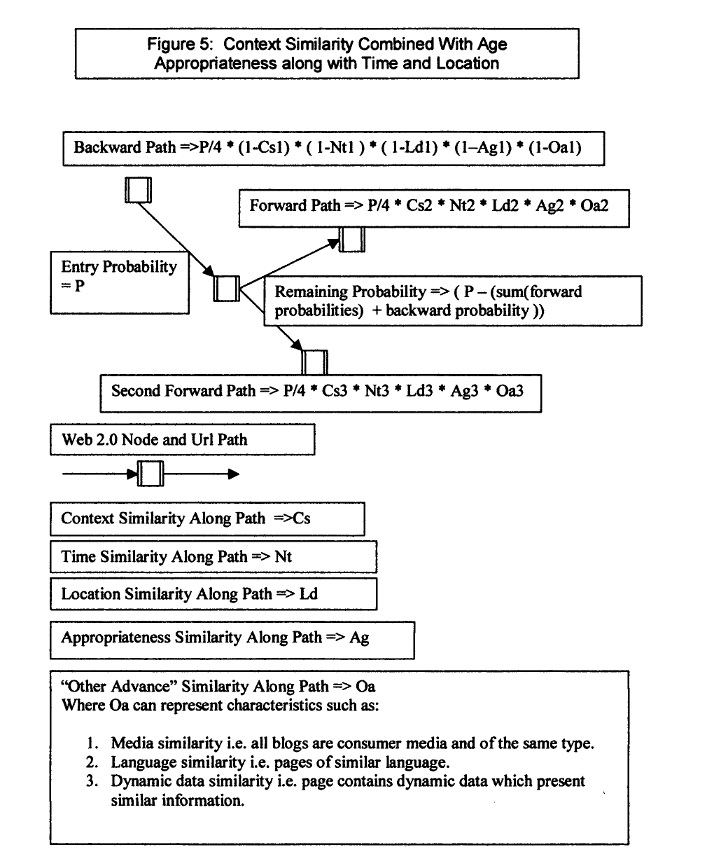

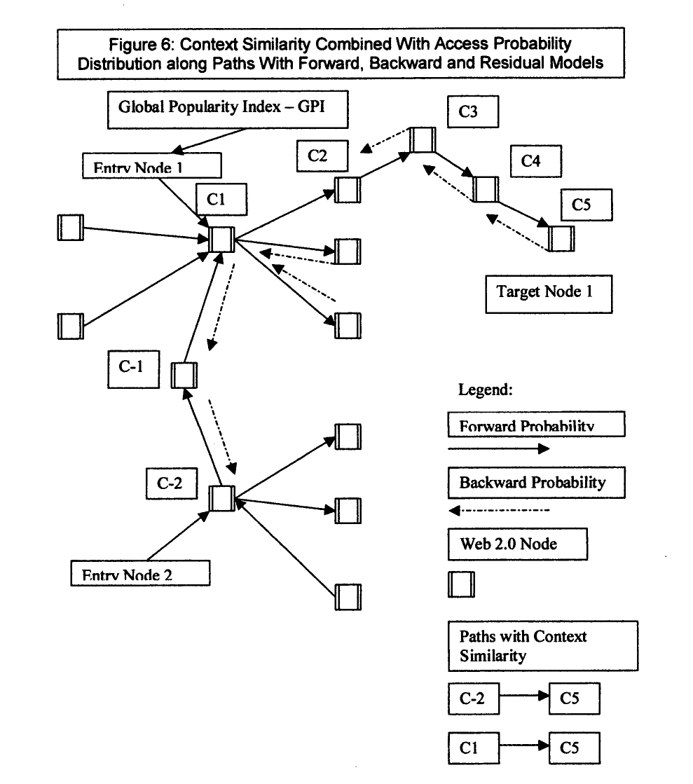

The FIG. 3 shows an embodiment of the invention with Time constraint as additional or optional factor used to assign higher probabilities to those Information Nodes along path that meet the Time constraint. The probability distribution is affected directly by time or newness factor (Nt). This model results in a time biased GPI of each Information Node, where some nodes which are intermediate along a path to a more relevant Information Node, may gain lower GPI than the end desirable result. Time constraints can be pre-stated by the system, in which case, we can compute this statically i.e. ahead of time, where-as time constraints may change from user query to user query, and hence this model may need to be dynamically computed each time instead of statically computing.

FIG. 4 shows an embodiment of the invention the use of Location constraint as the factor for Context Similarity, or optionally in addition to Time constraint, to assign higher probabilities to those Information Nodes along path that meet the Location and/or Location and Time criterion. The probability distribution is affected directly by location or distance factor (Ld). This model results in a location biased GPI of each Information Node, which not only considers text, but also context, time and location to develop a more complete relevance model for the end user query. Naturally, location can either be considered static to an Information Node, specified as a constraint, and hence so stated by system, or alternately be dynamic and hence system may not know ahead of time, and hence may need to be computed at run time.

FIG. 5 shows in an embodiment of the invention, the use of Age Appropriateness constraint or Similarity as additional or optional factor applied to assign higher probabilities to those Information Nodes along path that meet the age appropriateness criterion. The probability distribution is affected directly by appropriateness factor (Ag). This model results in an appropriateness biased GPI of each Information Node, which not only considers text, but also context, time, and location to develop a more complete relevance model for the end user query. Naturally, appropriateness can either be considered static to an Information Node, and hence so stated by system, or alternately be dynamic and hence system may not know ahead of time, and hence may need to be computed at run time This can immediately bring benefit to millions of parents who are increasingly sensitive towards over exposure to inappropriate content by the web to children. Present day search engines are agnostic to these considerations and yet are being used by all the children, often times resulting in undesirable consequences. The probability distribution is thus affected directly by advance operations similarity factor (Oa) in this case reflected by the age appropriateness constraint. Other embodiments of the invention for advance operational constraints (Oa), may utilize media element similarity such as photo similarity, or language similarity or other.

FIG. 6, shows an embodiment of the invention in which Global Popularity Index (GPI) is computed utilizing both Access Probability Distribution and Context Similarity, for each Information Node of the Information Engine, where such Information Node may be static or dynamic element, page, document or service.

What is claimed is:

1. A new method and system of “Information Engine” that brings together creation, origination, search, prioritization, access and utilization of information, and wherein prioritizes the information from each and every source of information computed as “Global Popularity Index”, and serves the information to web and mobile users worldwide on demand. The method and system can additionally but not limited to apply to mobile ready information or mobile web, where such information is acquired, searched, accessed and/or utilized using mobile and/or smart devices, resulting in a “Mobile Information Engine”.

2. The method of claim 1 wherein the “Global Popularity Index” or GPI is computed for each “static or dynamic multi-media information element, page, document or service”, defined as “Information Node”, to reflect global relevance of information and its information source to potential consumer queries posed to the Information Engine. A “multimedia web model of Information Engine is defined to consist of two or three levels of Information Nodes, i.e. element and page, or element, page and document”. where such element, page or document may be static or dynamic, such that final content or information of dynamic element, page or document is computed or is accessible at-least partially at run time, and hence can not be characterized by fully a priori.

3. The method of claim 1 wherein a “Service” Information Node is defined as software service or application interface available to user or applications over public networks (or over secure network if so required) with unique global identifier combined with a standards based service descriptor. This method provides for all potential services which can be uniquely addressed and have a clearly defined descriptor that the Information Engine can make use for identify the type of information they provide and using the interface to get information in real time, against user queries.

4. The method of claim 1 wherein within the multimedia Information Engine, an element may be included or referred to by several pages, and likewise, a page may be included or be referred to by several documents, and likewise, a service may be directly addressed or included in a dynamic element, dynamic page or dynamic document.

5. The method of claim 1 wherein upon a user or application driven information query, the Information Engine uses GPI to determine relative priority between the various information sources that qualify within a search scope, where “search scope” is a result of narrowing of information search base by use of “keywords, topic, content, time, location, appropriateness, user characteristics and other factors constituting dynamic relevance”; results so prioritized are presented to the end user against the specific query as “information, preview of information, and links to information, or combination thereof”.

6. The method of claim 2 wherein one method of computing Global Popularity index distributes “Information Access Probability” along potential click-through access paths (or URL Paths) leading to or originating from a static or dynamic information element, page, document or service i.e. Information Nodes and distributes possibilities along each such potential paths, to corresponding Information Nodes. In this method, important of a node is determined not by number or importance of adjacent links that point to it, but instead by the number of “contextually relevant” paths from important nodes that lead to or pass through a target node.

7. The method of claim 2 wherein a basic method is to treat all Information Nodes identical from a computation standpoint. A more complex extension of the method is to use priorities of contained and container Information Node to influence the target Information Node, though this may increase the computation time for the GPI for all Information Nodes.

8. The method of claim 2 wherein the “information access probability” along each path is distributed from the Information Node, such that effective probability reduces as the relative path length from origination Information Node increases; using “law of diminishing returns”, along each path in terms of new incremental value to the user with a user having “limited patience”.

9. The method of claim 2 wherein the probability distributed is compared with a pre-specified cutoff probability value and computation stops along each path, if the probability is computed to be below this value. This cutoff model ensures that distribution is limited to the extent it is valuable, while algorithm computation is simplified to allow for large parallel computations that current state of web requires.

10. The method of claim 2 wherein information access probability along a path may be uniformly or non-uniformly distributed, weighted based on a selectable criterion, starting from any Information Node, such as element, page, document or service, as well as a search results page, URL paths that lead to similar context Information Nodes are more likely to be of interest to user and hence method is enhanced to determine “Context Similarity” between two Information Nodes along a path.

11. The method of claim 2 wherein creating the concept of “User Model of Information Search” in which user traverses along a path, and may retrace back to session start Information Node, to start along another path (such as from any web page with multiple outgoing links or search results page with multiple results of interest), this leads to distribution of probability not only to forward Information Nodes along path but also backward, to model the retrace of user to get to an alternate path.

12. The method of claim 2 wherein “backward probability distribution” can be done uniformly, or be done non-uniformly to reduce backward probability assignment if context similarity is higher and vice versa. This is done to account for the consumer actions which reduce the chances of traversing back if more relevant content to context of interest is identified along a path; thereby improving the chance of reaching target information, even along longer paths. Conversely, the method increases the chances of user quickly retracing, if target web page is not of interest in current context.

13. The method of claim 2 wherein results in information access probability along paths leading to and leading from a static or dynamic Information Node, such as an element, page, document or service, where such probability is distributed forward, backward, and may have a remainder which is retained on the target element, page, document or service to reflect this target being the desired Information Node by user, and is done with a view to achieve higher probability distribution along paths of similar context, modeling a real user behavior closely to navigate through all these static and dynamic information sources intelligently to get to the most relevant information in present context.

14. The method of claim 2 wherein each of static or dynamic Information Nodes, or elements, pages, documents and services acquire probability that is distributed along paths, that is remainder, after each of the paths of each of elements, pages, documents and services, has been explored and probabilities distributed. This model ensures that even consumer created elements, pages, documents as well as application and web services, will be able to shine or become visible, if contextually relevant to user query, provided there exists at least one path to that Information Node.

15. The method of claim 2 wherein this entire process is carried out as successive cycles of processing, where each cycle results in a probabilistic state for each Information Node or information source of the global multi-media and web services based wired, wireless and mobile Internet, which is carried forward as starting probability state for the next cycle of computation, until a convergence criterion is met such as when variation in probabilities of all Information Nodes drops below a threshold probability.

16. The method of claim 2 wherein the above set of steps are performed each time the multimedia web is crawled for each Information Node, be it element, page, document or service; and/or new Information Node modifications are automatically notified by Information Node and thus acquired in real or near real time by Information Engine, where modified content is processed, for the incremental changes in the Information Node, and a new GPI is computed. The process therefore improves with time, as more and more Information Nodes with respective updates are collected and the Global Popularity Index increasingly begins reflecting what the theoretical relevance may be.

17. The method of claim 2 wherein, to do a cold start on the web for the first time, i.e. very first iteration may start with a different criterion to get the process started. In one embodiment, making probability threshold to be high that will result in paths traversal to be limited to only one step; and thereby creating a starting point, for subsequent iterations. This variant may be optionally deployed to improve the convergence of the system as a whole.

18. The method of claim 2 wherein, increase the probability of system to arrive at final Information Node directly, without having the user to actually do tracing and retracing of steps along various paths; representing number of queries and searches that a typical user performs to find specific information of interest with specific context; and therefore improving on the overall time for an effective search session.

19. The method of claim 2 wherein, can be subtended to subset of Information Nodes that contain specific keyword(s), or Context or Topics, to arrive at qualified relevance of Information Node within the specific subset.

20. The method of claim 2 is extended to use advance operational constraint or similarity as additional or optional factor applied to assign higher probabilities to those Information Nodes along path that meet such advance criterion. This model results in a special purpose GPI of each Information Node, which not only considers text, but also context, time, location, appropriateness, user characteristics, combined with other advance static or dynamic criterion to develop a more complete relevance model for the end user query.
